(19) United States
(12) Patent Application Publication
(10) Pub. No.: US 2013/0312869 A1
(43) Pub. Date: Nov. 28, 2013

(54) METHOD AND DEVICE FOR FILLING AN ELECTROCHEMICAL CELL

(71) Applicants: Andre Klien, Konigswartha OT Commerau (DE); Claus-Rupert Hohenthanner, Hanau (DE)

(72) Inventors: Andre Klien, Konigswartha OT Commerau (DE); Claus-Rupert Hohenthanner, Hanau (DE)

(73) Assignee: LI-TEC BATTERY GMBH, Kamenz (DE)

(21) Appl. No.: 13/989,664

(22) PCT Filed: Sep. 7, 2011
(86) PCT No.: PCT/EP2011/004510

§ 371 Date: Aug. 7, 2013

(30) Foreign Application Priority Data
Nov. 24, 2010 (DE) 10 2010 052 397.6

(51) Int. Cl. H01M 2/36

(52) U.S. Cl. CPC H01M 2/36
USPC 141/7; 141/59

(57) ABSTRACT

The invention relates to the filling of an electrochemical cell (10) with an electrolyte, said cell having, in its interior (12), at least one electrode stack and one casing which at least partially encloses the electrode stack(s). For filling to take place, a negative pressure is generated in the interior (12) of the cell (10) (step S3) and the interior (12) of the cell (10) is then connected to an electrolyte feed (24) (step S5). In order to ensure that the cell (10) is filled with the electrolyte in a uniform and total manner, a first pressure and a second pressure are alternatingly applied to an outer side (14) of the cell (10) while the electrolyte feed (24) is connected, the second pressure being lower than the first pressure (steps S6 and S7).

The present invention relates to a method and an apparatus for filling an electrochemical cell with an electrolyte.

The present invention is described in connection with lithium ion batteries for the supplying of motor vehicle drives. It is pointed out, however, that the invention can also be used independently of the chemistry and design of the electrochemical cell and battery and also independently of the type of drive to be supplied.

WO 2009/117809 A1 discloses a method and an apparatus for filling a battery cell with electrolyte using a fill head to which high pressure, vacuum or atmospheric pressure can be alternatively applied for a cell filling procedure in order to evacuate the cell and then pump the electrolytes inside the cell under pressure from above.

The invention is based on the object of providing an improved method for filling an electrochemical cell with electrolyte.

This is accomplished according to invention by the teaching of the independent claims. Preferred further developments of the invention constitute the subject matter of the subclaims.

The inventive method for filling an electrochemical cell with an electrolyte, wherein the electrochemical cell comprises at least one electrode stack and a casing at least partially enclosing the electrode stack(s) within its interior, comprises the step of generating a negative pressure in the interior of the cell (step S3); thereafter connecting the interior of the cell to an electrolyte feed (step S5); and alternatingly applying a first pressure and a second pressure to an exterior of the cell, wherein the second pressure is lower than the first pressure (steps S6 and S7).

Generating a negative pressure in the interior of the cell first removes the air from within the interior of the cell, and particularly from the interstices of the electrode stack, so that all of said interstices can be substantially completely filled during the subsequent electrolyte filling.

In order to ensure that the electrolyte flows between the electrode stack in sufficient quantity and is evenly distributed, the electrode stack is alternatingly compressed and expanded by a higher first and a lower second pressure being alternatingly applied to the exterior of the cell. Doing so creates a suction effect which effects the electrolyte being sucked in between the electrode stack.

The inventive method makes it possible to pump the electrolyte into the interior of the electrochemical cell without pressure since it is sucked into the interior of the cell due to the suction effect of the negative pressure in the interior of the cell and the suction effect due to alternatingly compressing and expanding the cell. This method is gentle on the components of the electrochemical cell and in particular prevents mechanical damages to the casing. However, it is also possible within the context of the invention to fill the cell with electrolyte under pressure.

An “electrochemical energy storage apparatus” is to be understood as any type of energy store from which electrical energy can be withdrawn, whereby an electrochemical reaction occurs within the interior of the energy store. The term encompasses energy stores of all types, particularly primary batteries and secondary batteries. The electrochemical energy storage apparatus comprises at least one electrochemical cell, preferentially a plurality of electrochemical cells. The plurality of electrochemical cells can be connected in parallel to store a larger amount of charge or connected in series to obtain a desired operating voltage or can form a combination parallel and series connection.

An “electrochemical cell” or “electrochemical energy storage cell” is to be understood in the present context as an apparatus which serves in the releasing of electrical energy, wherein the energy is stored in chemical form. In the case of rechargeable secondary batteries, the cell is also designed to absorb electrical energy, convert it into chemical energy and store it. The design (i.e. particularly the size and geometry) of an electrochemical cell can be selected as a function of the available space. The electrochemical cell is preferentially of substantially prismatic or cylindrical form. The present invention is particularly advantageously applicable to those electrochemical cells referred to as pouch cells or coffee bag cells, without the electrochemical cell of the present invention being limited to such application.

The substantially prismatic pouch cell preferably exhibits at least one opening or fill opening on one of its four edges, particularly preferentially its lower edge, through which the electrolyte is supplied. The lower edge of the pouch cell hereby refers to that edge which faces downward in the direction of gravity when in its operating position within the battery assemblage. This opening is sealed after filling.

The term “electrode stack” is to denote an assembly of at least two electrodes and an electrolyte arranged therebetween. The electrolyte can be partially accommodated by a separator, wherein the separator then separates the electrodes. The electrode stack preferably exhibits a plurality of electrode and separator layers, wherein the respective electrodes of like polarity are preferably electrically interconnected, particularly in parallel. The electrodes are for example of plate-shaped or film-like design and preferentially arranged substantially parallel to one another (prismatic energy storage cells). The electrode stack can also be coiled and exhibit a substantially cylindrical form (cylindrical energy storage cells). The term “electrode stack” is also to encompass such electrode coils. The electrode stack can comprise lithium or another alkali metal, also in ionic form.

The term “casing” encompasses any type of apparatus which is suited to preventing chemicals from leaking out of the electrode stack into the surroundings and protecting the components of the electrode stack against damaging external influences. The casing can be formed from one or more molded parts and/or be of film-like design. The casing can further be of single-layer or multi-layer configuration. In addition, the casing is preferably at least partially formed from an elastic material or of elastic design. The casing is preferably formed from a gas-tight and electrically insulating material or laminate structure. To the greatest extent possible, the casing preferentially encloses the electrode stack without any gaps or air pockets so as to enable good thermal conduction between the casing and the interior of the electrochemical cell.

“Negative pressure” denotes a pressure lower than atmospheric pressure. The negative pressure preferably forms a vacuum in the interior of the electrochemical cell. The negative pressure generated in the interior of the electrochemical cell in step S3 is preferably in a range of from approximately 1 to 50 kPa, preferentially in a range of from approximately 2 to 30 kPa, and further preferred in a range of from approximately 4 to 10 kPa.

The “first pressure” and the “second pressure” are initially predetermined wholly generally only to that extent that the second pressure is lower than the first pressure. In other words, the electrochemical cell is alternatingly subjected to two different pressures in steps S6 and S7 in order to produce the above-described suction effect for the electrolyte. In principle, both the first pressure and the second pressure can be selected to be higher than the atmospheric pressure, both the first pressure and the second pressure can be selected to be lower than the atmospheric pressure, the first pressure can be selected to be higher and the second pressure selected to be lower than the atmospheric pressure, or one of the first and second pressures can be selected to be substantially equal to the atmospheric pressure.

In steps S6 and S7, the first and second pressure is to be applied to “an exterior” of the electrochemical cell. This refers to pressurization over the largest area possible in order for the electrochemical cell to be subjected to pressure as uniformly as possible. In the case of a sub-stantially prismatic cell, it is preferable for at least all the major areas of the cell to be substan-tially subjected to the different first and second pressures; in the case of a substantially cylindrical cell form, it is preferable for at least the entire lateral surface of the cell to be substantially subjected to the different pressures.

In one preferential embodiment, the first pressure and the second pressure is generated on the exterior of the cell in steps S6 and S7 by a working fluid which substantially completely surrounds the electrochemical cell. A “working fluid” is thereby a gaseous or liquid medium.

Since the fluid applies the first and the second pressure to substantially the entire exterior of the cell in this embodiment, the most uniform possible application of pressure to the cell, and thus the electrode stack, ensues on all points and in all directions. Doing so reduces the risk of damaging the cell, particularly its casing and its electrode stack.

In one preferential embodiment of the invention, a difference between the first pressure and the second pressure in steps S6 and S7 is produced by means of a change in the volume and/or amount of the working fluid and/or by means of the working fluid flow. Changes to the volume and/or amount is preferably used in the case of a gaseous working fluid and the flow is used in the case of a liquid working fluid.

In another preferential embodiment of the invention, the first pressure and the second pressure is generated on the exterior of the cell in steps S6 and S7 by pressure plates which receive at least part of the cell between them.

The “pressure plates” are preferably plate-shaped components which rest against the exterior of the cell and can be moved substantially perpendicular to said cell exterior, or rollers of non-rotationally symmetric design (i.e. with an eccentric cross section, for example) and which rotate about a substantially fixed axis (i.e. at a fixed distance and parallel to the exterior of the cell).

In a further preferential embodiment, the cell is oscillated during steps S6 and/or S7 with the frequency of the oscillations being higher than the frequency of steps S6 and S7. To this end, the cell is preferably subjected to at least one acoustic pulse in step S6a, preferably at least one ultrasonic pulse. Such additional oscillations to which the cell is subjected can even better discharge any entrapped air in the cell or its electrode stack respectively, and can further improve the filling of the cell.

In one preferential embodiment of the invention, the alternating first pressure and second pressure in steps S6 and S7 is applied in pulses or pulsations. Preferably, one pulse duration during application of the first pressure and/or one pulse duration during application of the second pressure can thereby be varied when steps S6 and S7 are repeated.

A period of the first and the second pressure; i.e. essentially the sum of the first pressure pulse duration and the second pressure pulse duration, is preferably in the range of from approximately 2 to 20 seconds, preferentially in the range of from approximately 3 to 15 seconds, and further preferred in the range of from approximately 5 to 10 seconds.

The first pressure in steps S6 and S7 preferably corresponds to an ambient pressure of the cell (i.e. usually atmospheric pressure) or a positive pressure and the second pressure in steps S6 and S7 corresponds to an ambient pressure of the cell or a negative pressure. Preferentially, the first pressure substantially corresponds to the ambient pressure of the cell and the second pressure corresponds to a negative pressure.

A magnitude of the first pressure and/or a magnitude of the second pressure can preferably be varied during the repeating of steps S6 and S7.

In one preferential embodiment of the invention, the electrolyte is supplied to the electrochemical cell from below in steps S5 to S7. This approach advantageously allows being able to take advantage of capillary effects when filling the cell with the electrolyte. In other preferential embodiments, the electrolyte can also be filled into the electrochemical cell from the side or from above. In even further preferential embodiments of the invention, prior to filling, the electrochemical cell is disposed such that its fill opening is directed upward and opposite to the pull of gravity. Gravitational force thus advantageously supports the filling in accordance with the inventive method as the electrolyte flows downward in response to the gravitational pull.

In a further preferential embodiment of the invention, the inventive method further comprises a step S8 of detecting a fill level value of the electrolyte in the cell and steps S6 and S7 are repeated until the fill level value detected in step S8 reaches or exceeds a predetermined limit (step S9). Doing so ensures that the electrochemical cell will exhibit the electrolyte of a predetermined fill level upon the completion of the filling procedure.

As a function of the fill level value detected in step S7, a number of repetitions of steps S6 and S7 can thereby preferably be selected until the fill level value is next detected (step S11). Thus, the fill level value does not need to be checked as often at the start of the filling procedure as at the end of the filling procedure. Since a fill level value of the electrolyte in the cell is thereby not detected after each change in pressure effected in steps S6 and S7, the filling procedure of the cell as a whole can be shortened.

In a further preferential embodiment of the invention, the method further comprises a step S1 of sealing the electrochemical cell with the exception of at least one opening prior to step S3 so as to generate the negative pressure in step S3 and at least one opening for supplying the electrolyte in step S5. The two cited openings can selectively be different openings or the same opening. The casing is preferably provided with just one opening for realizing the filling procedure.

The term “sealing” is to be understood in terms of the present invention as a fluid-tight (i.e.

liquid-tight and gas-tight) connection of part of the casing to another component (particularly to e.g. another part of the casing or to a current conductor). The casing preferably exhibits a material or a material layer on its connection side which at least partially fuses and can be joined under pressure (so-called heat sealing).

The inventive apparatus for filling an electrochemical cell with an electrolyte, whereby the electrochemical cell has at least one electrode stack and a casing at least partially enclosing the electrode stack(s) in its interior, comprises the following components: a retention device for holding the electrochemical cell; a negative pressure device for generating a negative pressure in the interior of the cell held by the retention device; a feeder device for feeding an electrolyte into the interior of the cell held by the retention device; and a pressure device for applying at least two different pressures to the exterior of the cell held by the retention device.

The negative pressure device and the feeder device are preferably configured in the form of a collective filling device.

In one preferential embodiment of the invention, the pressure device comprises a fluid-filled pressure chamber in which the cell is disposed.

In another preferential embodiment of the invention, the pressure device comprises at least two pressure plates which accommodate at least part of the cell between them.

One preferential embodiment of the invention additionally provides for a vibration generator able to oscillate the cell, with the frequency of the oscillations being higher than the frequency of pressurization with the at least two different pressures.

In a further preferential embodiment of the invention, the apparatus for filling the cell is disposed in a vacuum chamber.

In one preferential configuration of the invention, the apparatus is designed to simultaneously fill a plurality of electrochemical cells with an electrolyte. This measure can accelerate the manufacturing of a plurality of electrochemical cells.

With respect to the advantages and the terms used, the remarks made above in conjunction with the inventive method apply accordingly. The inventive apparatus for filling an electrochemical cell with an electrolyte is particularly suited to realizing the inventive method.

The above-described method and the above-described apparatus of the invention can be advantageously used in the manufacturing of electrochemical energy storage devices in the form of lithium-ion secondary batteries for supplying motor vehicle drives. However, the invention can naturally also be used in other applications.

Further advantages, features and possible applications of the present invention ensue from the following description in conjunction with the figures, which show:

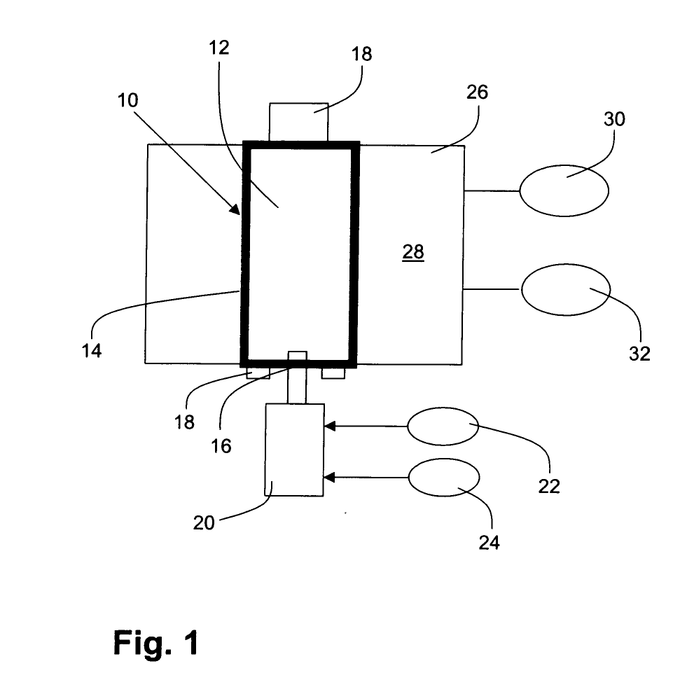

FIG. 1 a schematic depiction of the structure of an apparatus for filling an electrochemical cell in accordance with a first embodiment of the present invention;

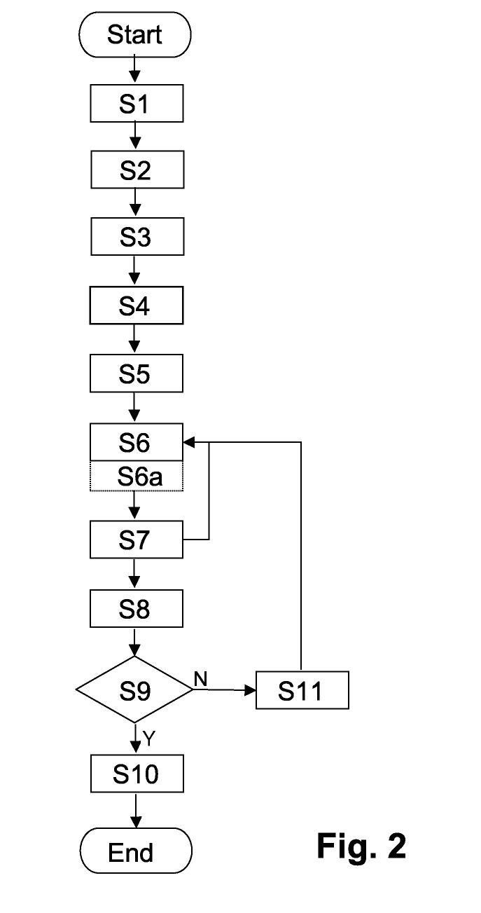

FIG. 2 a flow chart clarifying the process flow of filling an electrochemical cell with an electrolyte according to the present invention; and

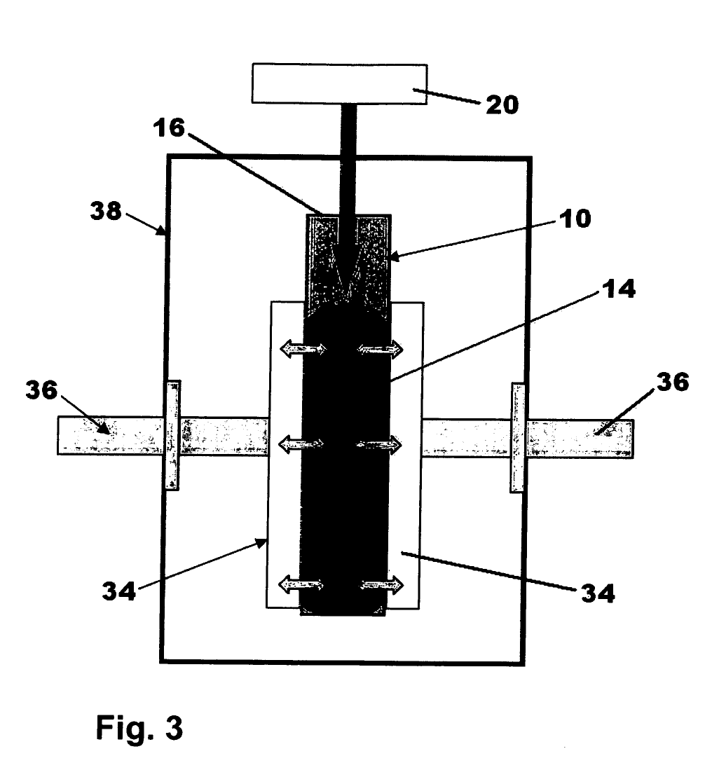

FIG. 3 a schematic depiction of the structure of an apparatus for filling an electrochemical cell in accordance with a second embodiment of the present invention.

FIG. 1 shows a highly simplified depiction of an apparatus for filling an electrolyte into an electrochemical cell 10. An electrode stack to be filled with an electrolyte is arranged in the interior 12 of the cell 10. A casing distinguishes the interior 12 of the cell from the surroundings of the cell and defines an exterior 14 of the cell 10.

The cell 10 exhibits at least one opening 16 which is used in performing the filling procedure. The cell 10 is held in a suitable retention device 18 for the filling procedure. As FIG. 1 shows, the cell 10 in this embodiment is held in inverted position so that the electrolyte can flow into the interior 12 of cell 11 from below via capillary effect.

The opening 16 of the cell 10 is connected to a fill head 20 which itself is in turn connected to a negative pressure source 22 and an electrolyte supply 24. A negative pressure can thus be selectively generated in the interior 12 of the cell 10 with this fill head 20, for example a vacuum on the order of magnitude of approximately 5 kPa, or the interior 12 of the cell 10 can be connected to an electrolyte feed. The electrolyte from the electrolyte supply 24 can thereby be sucked into the interior 12 of the cell 10 due solely to the capillary effect and a suction effect or can additionally be pumped into cell 10 under some degree of pressure.

As illustrated in FIG. 1, the cell 10 is surrounded by a pressure chamber 26 which encloses the exterior 14 of the cell 10 as completely as possible. This pressure chamber 26 is filled with a fluid 28; i.e. a gas or a liquid which bears as evenly as possible on the exterior 14 of the cell 10 on all sides and thus exerts an equal pressure from all directions on the cell 10 and thereby on the electrode stack in the interior 12 of the cell 10.

The pressure chamber 26 is connected to a first pressure source 30 and a second pressure source 32. In this embodiment, the first pressure source 30 generates a fluid pressure in the interior of the pressure chamber 26 which substantially corresponds to the ambient and/or atmospheric pressure and the second pressure source 32 generates a fluid pressure in the interior of the pressure chamber 26 which corresponds to a negative pressure; i.e. a lower pressure than the ambient pressure generated by the first pressure source 30.

The two pressure sources 30, 32 can also be alternatively designed as one common device. It is also possible to design the first pressure source 30 as source of positive pressure and the second pressure source 32 as a source of ambient pressure.

For the filling of the cell 10 with electrolyte, the pressure chamber 26 can be alternatingly operated with the first and the second pressure source 30, 32.

FIG. 2 shows an exemplary operational sequence of filling electrolyte into an electrochemical cell in accordance with the invention which can be performed with the apparatus described above.

In a first step S1, the electrochemical cell 10 is sealed with the exception of fill opening 16. The sealed cell 10 is then received in inverted position in the retention device 18 and connected to the fill head 20 (step S2).

In a step S3, a negative pressure or vacuum is generated in the interior 12 of the cell 10 by means of the negative pressure source 22 connected to the fill head 20; i.e. the cell 10 is evacuated so as to remove the gases from the cell 10. In an (optional) step S4, during or after the evacuation in step S3, the first pressure source 30 generates an ambient pressure on the fluid 28 within pressure chamber 26.

Then, in a step S5, the interior 12 of the cell 10 is connected to the electrolyte supply 24 via fill head 20 in order to supply the electrochemical cell 10 with the electrolyte from below. Due to the negative pressure in the interior 12 of the cell 10 and due to capillary effect, the electrolyte flows through opening 16 into the interior 12 of cell 10 and between the electrode stack.

Steps S6 and S7 are then performed to achieve a uniform and complete filling of the cell 10 with the electrolyte, whereby these steps S6 and S7 are repeated. In step S6, first the ambient pressure (first pressure) is applied to the exterior 14 of the cell 10 in the pressure chamber 26 by means of the first pressure source 30. Subsequently, in step S7, a negative pressure (second pressure) is applied to the exterior 14 of the cell 10 in the pressure chamber 26 by means of the second pressure source 32. By alternatingly compressing and expanding the cell 10 and the electrode stack, the electrolyte can be moved out of the electrolyte supply 24 and through the electrode stack faster and more uniformly.

The pulse duration of the first pressure and the second pressure in the fluid 28 of the pressure chamber 26 can be varied during the course of a filling operation. For example, the pulsed application of pressure on the exterior 14 of the cell over the course of the filling operation can occur at ever higher frequency. The period of a pulse sequence of a first pressure and a second pressure is, for example, within the range of approximately 2 to 20 seconds and amounts, for example, to approximately 5 seconds.

In a next step S8, a fill level value for the electrolyte in the electrochemical cell 10 is detected. In a step S9, the detected fill level value is then compared to a predefined limit value.

Should the detected fill level value reach or exceed the predefined limit value (YES in step S9), the filling operation for this cell 10 is concluded and, in step S10, ambient pressure is again applied to the exterior 14 of the cell 10 in the pressure chamber 26 and the interior 12 of the cell 10 is separated from the electrolyte supply 24.

Otherwise (NO in step S9), depending on the fill level value detected in step S8, the number of repetitions of steps S6 and S7 is determined and the method reverts to step S6 again so as to resume the alternating pressurization of the exterior 14 of cell 10. The filling pursuant steps S6 to S8 is continued until the fill level value of the electrolyte reaches or exceeds the predefined limit value.

The apparatus for filling electrolyte into the electrochemical cell 10 is thereby preferably designed so as to simultaneously fill a plurality of cells with electrolyte in accordance with the method depicted in FIG. 2.

A second embodiment of filling electrolyte into a electrochemical cell will now be described with reference to FIGS. 3 and 2. The same or analogous components and method steps are thereby labeled with the same reference numerals as in the above first embodiment.

The cell 10 with the electrode stack and the casing exhibits at least one opening 16 by means of which the filling operation can be realized. The cell 10 is held in a suitable retention device for the filling operation. As depicted in FIG. 3, the cell 10 in this example is held such that the fill opening 16 faces upward opposite to the pull of gravity so that gravitational force can contribute to the electrolyte flowing downward into the interior 12 of the cell 10.

The opening 16 of cell 10 is connected to a fill head 20 which is in turn connected to a source of negative pressure and a supply of electrolyte. A negative pressure can thus be generated within the cell 10, for example a vacuum on the order of magnitude of approximately 5 kPa, or the interior 12 of the cell 10 can selectively be connected to an electrolyte feed via said fill head 20. The electrolyte from the electrolyte supply can thereby be sucked into the interior of the cell 10 due solely to the capillary effect and a suction effect or can additionally be pumped into cell 10 under some degree of pressure.

As FIG. 3 illustrates, the cell 10 is received between two pressure plates 34 which each preferably abut against an entire main surface of the exterior 14 of the cell. The pressure plates 34 are pressed against the exterior 14 of the cell 10 by means of a not-shown pressure generating device.

The pressure plates 34 thereby alternatingly apply a first pressure, which substantially corresponds to the ambient and/or atmospheric pressure, and a second pressure, which corresponds to a negative pressure; i.e. a pressure below the ambient pressure, to the cell 10.

As an additional measure, the two pressure plates 34, or selectively just one of same, are each coupled to a sonotrode 36 of an ultrasound generating apparatus. By so doing, the pressure plates 34 can be subjected to an ultrasonic pulse when the higher first pressure is applied to cell 10. The additional higher-frequency oscillations thereby generated, which will pass to the cell, ensure that even tiny air pockets will be evacuated from the cell 10 during the defined compressing of the cell 10 and thus all the wetting surfaces of the electrode stack will be sufficiently moistened by the electrolyte; i.e. electrode and separator “dry” spots will be prevented.

The entire assembly for filling the cell 10 with an electrolyte is further disposed in a vacuum chamber 38; i.e. the filling operation preferably occurs in a vacuum.

The electrolyte filling sequence for a cell 10 with this apparatus of the second embodiment likewise follows the flow chart of FIG. 2.

In a step S5 subsequent to steps S1 to S4, the interior 12 of the cell 10 is connected to the electrolyte supply via the fill head 20 in order to supply the electrolyte to the electrochemical cell 10 from above. The electrolyte flows through opening 16 into the interior of the cell 10 and between the electrode stack due to the negative pressure inside the cell 10 and due to capillary effect.

Steps S6, S6a and S7 are then performed in order to achieve a uniform and complete filling of the cell 10 with the electrolyte, whereby these steps are performed repeatedly. In step S6, the exterior 14 of the cell 10 is first subjected to a higher first pressure by means of pressure plates 34. At least one of the two pressure plates 34 is thereby additionally subjected to an ultrasonic pulse (step 6a) during this process so as to eliminate all possible air pockets there may be from the interior of the cell 10. The pressure plates 34 thereafter subject the cell 10 to a lower second pressure in step S7. The alternating compression and expansion of the cell 10 and the electrode stack allows the electrolyte to be moved out of the electrolyte supply and through the electrode stack faster and more uniformly.

The pulse duration of the pressurization with the first pressure and the second pressure can thereby be varied over the course of a filling operation as in the above first embodiment. In addition, the fill state of the cell 10 is preferably monitored as in the above first embodiment (steps S8, S9, S11).

Should the detected fill state value reach or exceed the predefined limit value (YES in step S9), the filling operation for this cell 10 is concluded and, in step S10, ambient pressure is again applied to the exterior 14 of the cell 10 in the vacuum chamber 26 and the interior 12 of the cell 10 is also separated from the electrolyte supply.

The embodiments depicted in FIGS. 1 to 3 can additionally be combined with one another. Thus, also in the first embodiment, the cell 10 can for example be subjected to an acoustic pulse, preferentially an ultrasonic pulse, during the fluid 28 pressurization in order to further improve the filling of the cell 10.

1-20. (canceled)

21. A method for filling an electrochemical cell with an electrolyte, wherein the electrochemical cell comprises at least one electrode stack and a casing at least partially enclosing the electrode stack(s) within its interior, the method comprising:
generating a negative pressure in the interior of the cell (step S3);
subsequent to step S3, connecting the interior of the cell to an electrolyte feed (step S5); and
alternatingly applying a first pressure and a second pressure to an exterior of the cell, wherein the second pressure is lower than the first pressure (steps S6 and S7).

22. The method according to claim 21, wherein the first pressure and the second pressure is generated on the exterior of the cell in steps S6 and S7 by a working fluid which substantially completely surrounds the electrochemical cell.

23. The method according to claim 22, wherein a difference between the first pressure and the second pressure in steps S6 and S7 is produced by means of a change in the volume and/or amount of the working fluid and/or by means of the working fluid flow.

24. The method according to claim 21, wherein the first pressure and the second pressure is generated on the exterior of the cell in steps S6 and S7 by pressure plates which receive at least part of the cell between them.

25. The method according to claim 21, wherein the cell is oscillated during steps S6 and/or S7 (step S6a), wherein the frequency of the oscillations is higher than the frequency of steps S6 and S7.

26. The method according to claim 25, wherein the cell is subjected to at least one acoustic pulse in step S6a.

27. The method according to claim 21, wherein the alternating first pressure and second pressure in steps S6 and S7 is applied in pulses or pulsations.

28. The method according to claim 27, wherein one pulse duration during application of the first pressure and/or one pulse duration during application of the second pressure can be varied when steps S6 and S7 are repeated.

29. The method according to claim 21, wherein the first pressure in steps S6 and S7 corresponds to an ambient pressure of the cell or a positive pressure.

30. The method according to claim 21, wherein the second pressure in steps S6 and S7 corresponds to an ambient pressure of the cell or a negative pressure.

31. The method according to claim 21, wherein a magnitude of the first pressure and/or a magnitude of the second pressure is variable during the repeating of steps S6 and S7.

32. The method according to claim 21, further comprising a step S8 of detecting a fill level value of the electrolyte in the cell, and steps S6 and S7 are performed until the fill level value detected in step S8 reaches or exceeds a predetermined limit (step S9).

33. The method according to claim 32, wherein a number of repetitions of steps S6 and S7 until the fill level value is next detected (step S11) is selected as a function of the fill level value detected in step S7.

34. An apparatus for filling an electrochemical cell with an electrolyte, wherein the electrochemical cell comprises at least one electrode stack and a casing at least partially enclosing the electrode stack(s) within its interior, particularly for realizing a method in accordance with claim 21, the apparatus comprising:
a retention device configured to hold the electrochemical cell;
a negative pressure device configured to generate a negative pressure in the interior (12) of the cell held by the retention device;
a feeder device configured to feed an electrolyte into the interior of the cell held by the retention device; and
a pressure device configured to apply at least two different pressures to the exterior of the cell held by the retention device.

35. The apparatus according to claim 34, wherein the negative pressure device and the feeder device are configured in the form of a collective filling device.

36. The apparatus according to claim 34, wherein the pressure device comprises a pressure chamber filled with a fluid in which the cell is disposed.

37. The apparatus according to claim 34, wherein the pressure device comprises at least two pressure plates which accommodate at least part of the cell between them.

38. The apparatus according to claim 34, further comprising a vibration generator configured to oscillate the cell, with the frequency of the oscillations being higher than the frequency of pressurization with the at least two different pressures.

39. The apparatus according to claim 34, wherein the apparatus is disposed in a vacuum chamber.

40. The apparatus according to claim 34, wherein the apparatus is configured to simultaneously fill a plurality of electrochemical cells with an electrolyte.
